(19) United States
(12) Patent Application Publication
(10) Pub. No.: US 2010/0115107 A1
(43) Pub. Date: May 6, 2010

(54) COMMUNICATION DEVICE

(75) Inventors: Takashi Mitsuhashi, Kawasaki (JP); Takashi Kitano, Kawasaki (JP); Kazuo Ohshima, Kawasaki (JP); Yuji Tajima, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/688,069

(22) Filed: Jan. 15, 2010

Related U.S. Application Data
(63) Continuation of application No. PCT/JP2007/000925, filed on Aug. 29, 2007.

(51) Int. Cl. G06F 15/16

(52) U.S. Cl. 709/227

(57) ABSTRACT

When a communication route is established between SIP servers #1 and #3, an SIP server #2 performing a relay between the servers #1 and #3 receives an INVITE signal from the SIP server #1, not describing track information about the SIP server #2 in a Via header and a Record-Route header of the INVITE signal, but transferring the signal to the SIP server #3. Thus, after the transferred INVITE signal, the signal transmitted and received by the SIP servers #1 and #3, does not include the track information about the SIP server #2, thereby transmitting the signal without passing through the SIP server #2.

### CROSS-REFERENCE TO THE RELATED APPLICATION

This application is a continuation of International PCT application PCT/JP2007/000925, filed on Aug. 29, 2007.

### FIELD

The embodiments of the present invention relate to a communication device.

### BACKGROUND

Recently, the technology of performing communications between IP telephones, between an IP telephone and an analog telephone, and between an IP telephone and an ISDN telephone has been realized. In the communications using the IP network, a SIP (session initiation protocol) is used to establish a communication circuit. In the signal transmission/reception using an SIP, the passing route of an SIP signal is controlled by a Via header and a Record-Route header of the SIP signal.

In the signal transmission/reception using an SIP, a call raise request signal through a response signal of a call disconnect request in communications constantly pass through the route through which an initial request signal has passed according to the passing route information on the SIP signal.

However, since a SIP server through which a SIP signal passes includes an allocation server which has to pass only through the initial request signal etc. that determines a path depending on the locality, the SIP signal redundantly passes through the SIP server through which the signal does not have to pass, thereby taking wasteful signal transmitting/receiving time, and imposing an excess load on an allocation SIP server having no problem without passing the signal through the server.

FIG. 1 is an explanatory view of the outline of the network for performing communications through an SIP server.

For example, if there is a service conditions of a fixed fee etc. in the communications in an area A, and when a communication is established from an SIP terminal under an SIP server #Aa to an SIP server under an SIP server #Ac, then it is necessary to pass through the SIP server #A that knows the destination SIP server. However, if the destination SIP server (#Ac) can be designated by the initial request signal, it is not necessary to always pass through the SIP server #A in performing the communication in the area A. However, in the communication spanning the areas A and B, if it is necessary to consider the inter-area fee, a signal has to always pass through the SIP server #1. Thus, the SIP server includes a server required to pass a signal through, and a server that does not require all signals. In the prior art technology, all SIP signals are transferred through an SIP server in the initially set route.

FIG. 2 illustrates an SIP signal transmission/reception sequence when there is a single pass-by server in the prior art technology.

In FIG. 2, the SIP server #1 is establishing a communication route to the SIP server #3. The SIP server #2 is not required to always pass through an allocation server for allocating a signal to each region. When a communication route is to be established to the SIP server #3, the SIP server #1 transmits an INVITE signal as an initial request signal. The INVITE signal stores the identifier of a source server in the Via header of the INVITE signal. In this example, it is described as the SIP server #1. The Via header refers to route information for designation of a route to be traced by an answer signal to an issued signal. A Record-Route header also stores the identifier of the SIP server #1. The Record-Route header refers to route information describing a route to be traced by all signals after the communications of the initial request signal and its answer signal. When the SIP server #2 receives the INVITE signal from the SIP server #1, the server transfers the INVITE signal to the SIP server #3. In this case, the SIP server #2 adds the information about the server to the Via header of the INVITE signal. In addition, the information about the server is added to the Record-Route header. In this example, the identifier about the SIP server #2 is added. Thus, the answer signal to the INVITE signal describes the SIP server #2 as being passed through.

When the SIP server #3 receives the INVITE signal, it transmits the 180Ringing/2000K signal as an answer signal. In this case, the SIP server #3 describes the Via header and the Record-Route header of the received INVITE signal to the Via header and the Record-Route header of the 180Ringing/2000K signal. As the information about a source, the Contact header describes the identifier of the SIP server #3. The 180Ringing/2000K signal is transmitted to the SIP server #2 according to the information about the Via header. When the SIP server #2 receives the 180Ringing/2000K signal, it deletes the Via header having its identifier from the 180Ringing/2000K signal, and transfers the signal to the SIP server #1. By the SIP server #1 receiving the 180Ringing/2000K signal, a communication route is established between the SIP servers #1 and #3. The established communication route is acquired according to the information about the Record-Route header. Therefore, a communication route through the SIP server #2 is used in the communication between the SIP servers #1 and #3. That is, as destination information, an ACK/BYE signal from the SIP server #1 to the SIP server #3 is transmitted after setting the identifier of the server #3 in the Request-URI header, the identifier of the SIP server #1 in the Via header, and the identifier of the SIP server #2 in the Route header. The ACK/BYE signal is transmitted to the SIP server #3 after adding a Via header describing the identifier of the SIP server #2.

FIG. 3 illustrates the SIP signal transmission/reception sequence when there are a plurality of pass-by servers in the prior art technology.

In FIG. 3, the SIP server #1 is establishing a communication route to the SIP server #4. It is normally unnecessary to pass through the SIP servers #2 and #3 as, for example, allocation servers for allocating a signal to each area. When the SIP server #1 is establishing a communication route to the SIP server #4, it transmits the INVITE signal as the initial request signal to the SIP server #4. The INVITE signal stores the identifier of the source server in the Via header of the INVITE signal. In this example, it is described as the SIP server #1. The Via header refers to route information for designating the route to be traced by an answer signal in response to an issued signal. The Record-Route header also stores the identifier of the SIP server #1. The Record-Route header refers to route information describing the route to be traced by all signals after the transmission/reception of the initial request signal and its answer signal. When the SIP server #2 receives the INVITE signal from the SIP server #1, it transfers the INVITE signal to the SIP server #3. In this case, the SIP server #2 adds the information about the server to the Via header of the INVITE signal. It also adds the information about the server to the Record-Route header. In this example, the identifier of the SIP server #2 is added. Thus, the necessity for the answer signal in response to the INVITE signal to pass through the SIP server #2 is described. When the SIP server #3 receives the INVITE signal from the SIP server #2, it transfers the INVITE signal to the SIP server #4. In this case, the SIP server #3 adds the information about the server to the Via header of the INVITE signal. The information about the server is also added to the Record-Route header. In this example, the identifier of the SIP server #3 is added. Thus, the necessity for the answer signal in response to the INVITE signal to pass through the SIP server #3 is described.

When the SIP server #4 receives the INVITE signal, it transmits the 180Ringing/2000K signal as an answer signal to the SIP server #1. In this case, the SIP server #4 describes the Via header and the Record-Route header to the Via header and the Record-Route header of the 180Ringing/2000K signal. As the information about the source, the Contact header describes the identifier of the SIP server #4. The 180Ringing/2000K signal is transmitted to the SIP server #3 according to the information about the Via header. When the SIP server #3 receives the 180Ringing/2000K signal, it deletes the Via header having the identifier from the 180Ringing/2000K signal, and transfers the signal to the SIP server #2. The 180Ringing/2000K signal is further transmitted to the SIP server #2 according to the information about the Via header. When the SIP server #2 receives the 180Ringing/2000K signal, it deletes the Via header having the identifier from the 180Ringing/2000K signal, and transfers the signal to the SIP server #1.

By the SIP server #1 receiving the 180Ringing/2000K signal, a communication route is established between the SIP servers #1 and #4. The established communication route is acquired according to the information about the Record-Route header. Therefore, in the subsequent communication between the SIP servers #1 and #4, the communication route through the SIP servers #2 and #3 is used. That is, as destination information, an ACK/BYE signal from the SIP server #1 to the SIP server #4 is transmitted after setting the identifier of the server #4 in the Request-URI header, the identifier of the SIP server #1 in the Via header, and the identifiers of the SIP servers #2 and #3 in the Route header. The ACK/BYE signal is transmitted to the SIP server #3 after adding a Via header describing the identifier of the SIP server #2. The ACK/BYE signal is transmitted to the SIP server #4 after adding the Via header describing the identifier of the SIP server #3 in the SIP server #3.

The prior art technology described in the patent document 1 discloses, in the technique of establishing a communication connection through the Internet between different ISPs and carriers, direct communications from a source communication terminal to a destination communication terminal without a gate keeper belonging to the destination communication terminal.

Patent Document 1: Japanese Laid-open Patent Publication No. 2006-135918

### SUMMARY

A source communication device according to an aspect of the present invention performs communications through a protocol for establishing a communication route, and includes a transfer device for receiving a signal, not setting normally set information about the source communication device in the received signal, but transferring the received signal to another communication device, thereby not notifying the other communication device of the information about the source communication device and transferring the signal through a route bypassing the source communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 is an explanatory view of the outline of the network over which communications are performed through a SIP server;

FIG. 2 illustrates the SIP signal transmission/reception sequence when there is a single pass-by server according to the prior art technology;

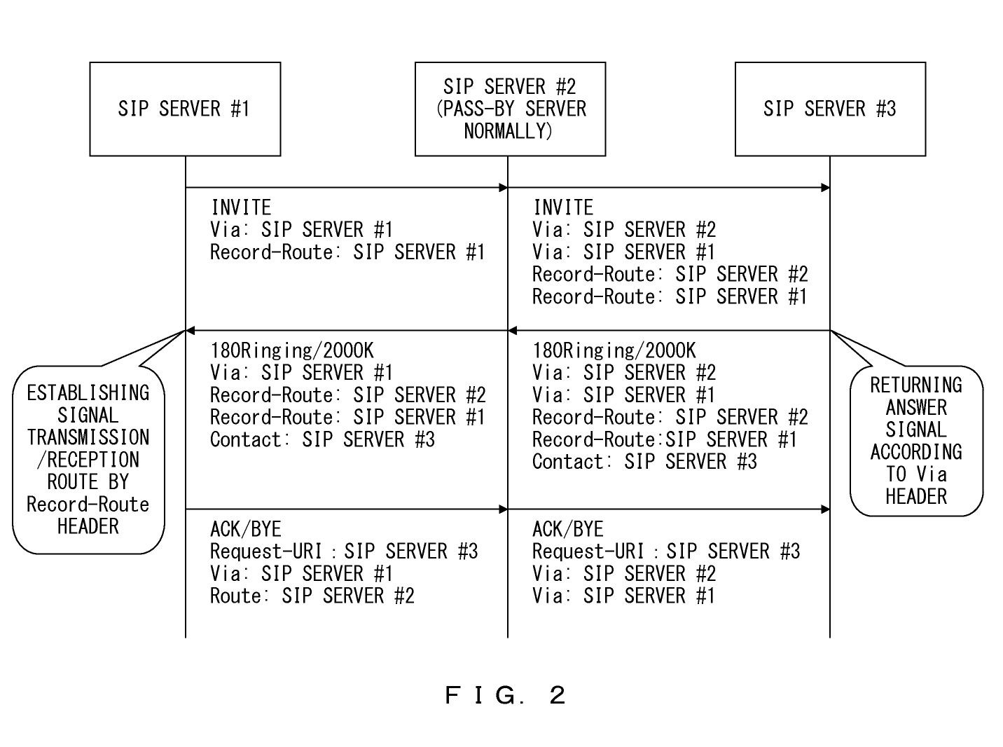

FIG. 3 illustrates the SIP signal transmission/reception sequence when there are a plurality of pass-by servers according to the prior art technology;

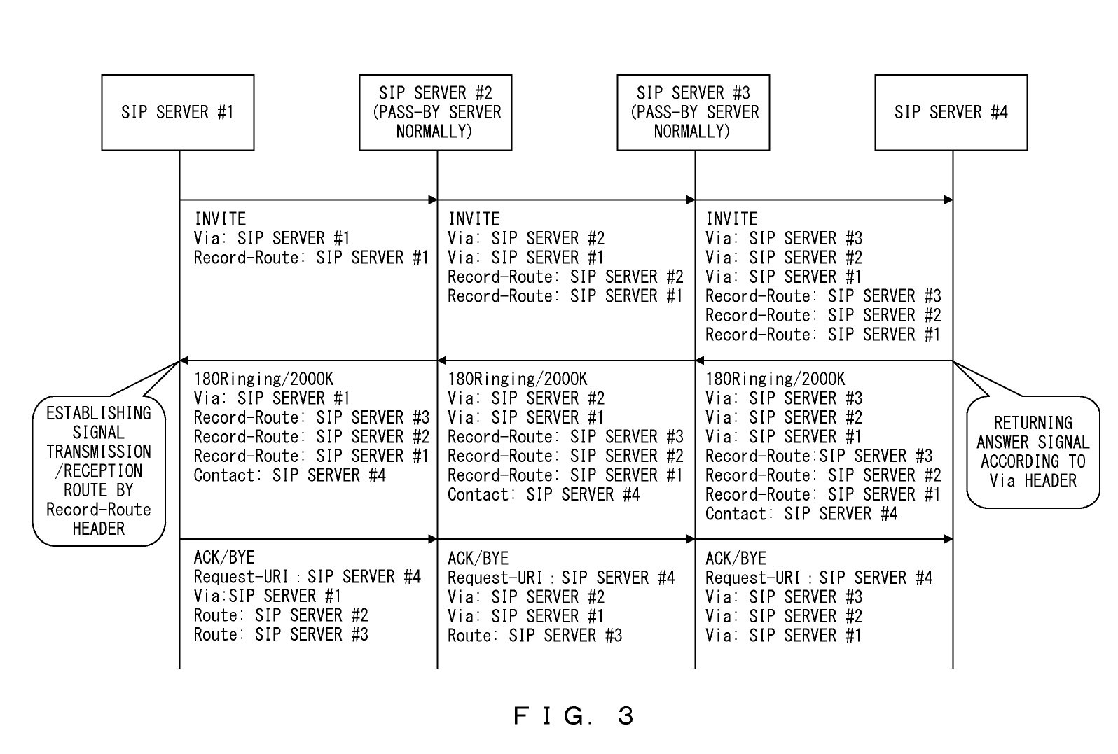

FIG. 4 is an explanatory view of the outline of an embodiment of the present invention;

FIG. 5 illustrates the SIP signal transmission/reception sequence when there is a single pass-by server according to an embodiment of the present invention;

FIG. 6 illustrates the SIP signal transmission/reception sequence (1) when there are a plurality of SIP servers between a source and a destination according to an embodiment of the present invention;

FIG. 7 illustrates the SIP signal transmission/reception sequence (2) when there are a plurality of SIP servers between a source and a destination according to an embodiment of the present invention;

FIG. 8 is a flowchart of the operation of the SIP servers #1, #A, and #B illustrated in FIG. 1;

FIG. 9 is a block diagram of the functions of the SIP servers #1, #A, and #B illustrated in FIG. 1; and

FIG. 10 is an explanatory view of an example of a variation of an embodiment of the present invention.

### DESCRIPTION OF EMBODIMENTS

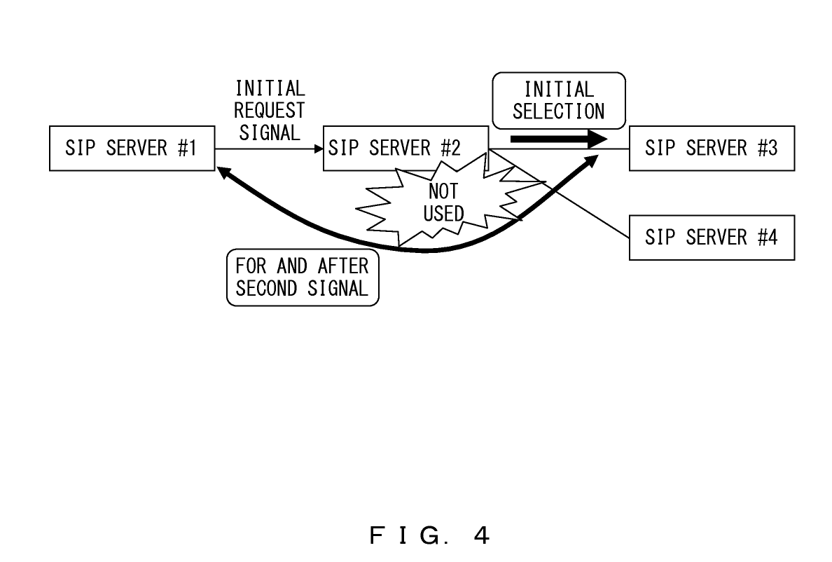

FIG. 4 is an explanatory view of the outline of an embodiment of the present invention.

The SIP server #2 is an allocation server, and allocates a signal from the SIP server #1 to the SIP servers #3 and #4. Assume that the SIP server #1 issues an initial request signal to the SIP server #3. When the SIP server #2 transfers the initial request signal, it selects the route to the SIP server #3 as the first path selection. When the initial request signal is transmitted to the SIP server #3, the SIP server #2 is free of the relay function between the SIP servers #1 and #3, and subsequent signals after the answer signal in response to the initial request signal from the SIP server #3 to the SIP server #1 are transferred without the SIP server #2. In FIG. 4, only the route through the SIP server #2 is illustrated between the SIP servers #1 and #3 as a communication route of a signal. However, actually it is assumed that communication paths connect the SIP servers to one another in mesh form.

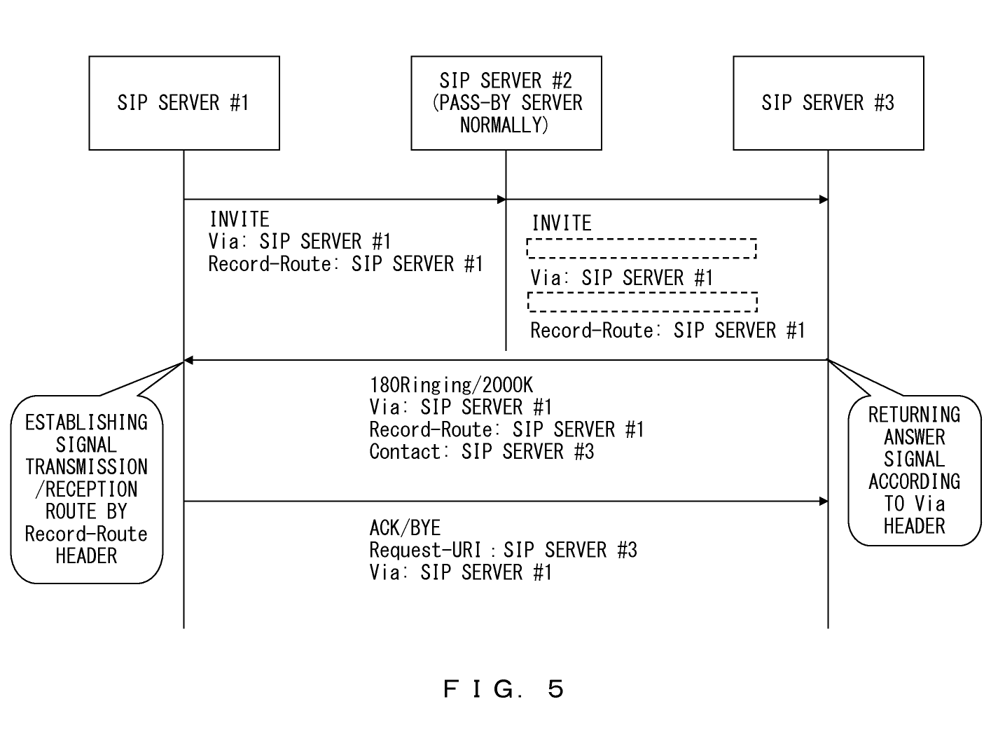

FIG. 5 illustrates the SIP signal transmission/reception sequence when there is a single pass-by server according to an embodiment of the present invention

In the signal transmission/reception among the SIP servers #1 through #3, the SIP server #2 receives the call raise request signal (INVITE: initial request signal) received from the SIP server #1, and selects the SIP server #3 as the next destination of the signal according to the signal destination selection logic of the SIP server #2. In this case, the Via header and the Record-Route header are assigned as the track of the SIP server #2, and the name (or the address or the identifier) of the SIP server #2 is set in the prior art technology. However, the assignment and the setting are not performed, but the call raise request signal (INVITE) is transmitted to the SIP server #3 without the track of the SIP server #2.

When the SIP server #3 receives the call raise request signal (INVITE), it uses the Via header as the destination of a response signal to be returned. However, since there is only the track of the SIP server #1, the response signal (1XX through 6XX signals such as the 180Ringing, 200 OK etc.) to the call raise request signal (INVITE) to the SIP server #1, is sent.

When the SIP server #1 receives the response signal to the call raise request signal (INVITE), it uses the Record-Route header in the new request signal transmission for the same call. However, when there is only the track of the server (SIP server #1), the SIP server #3 set in the Contact header is set as the final destination server, and the name (or address or identifier) of the SIP server #3 is set as the destination in the Request-URI and transmitted.

As described above, when a signal is transferred in a pass-by SIP server, the pass-by server can be skipped for the signal transmitted and received after the initial signal only by suppressing the description to the Via header and the Record-Route header without changing the operations of other SIP servers.

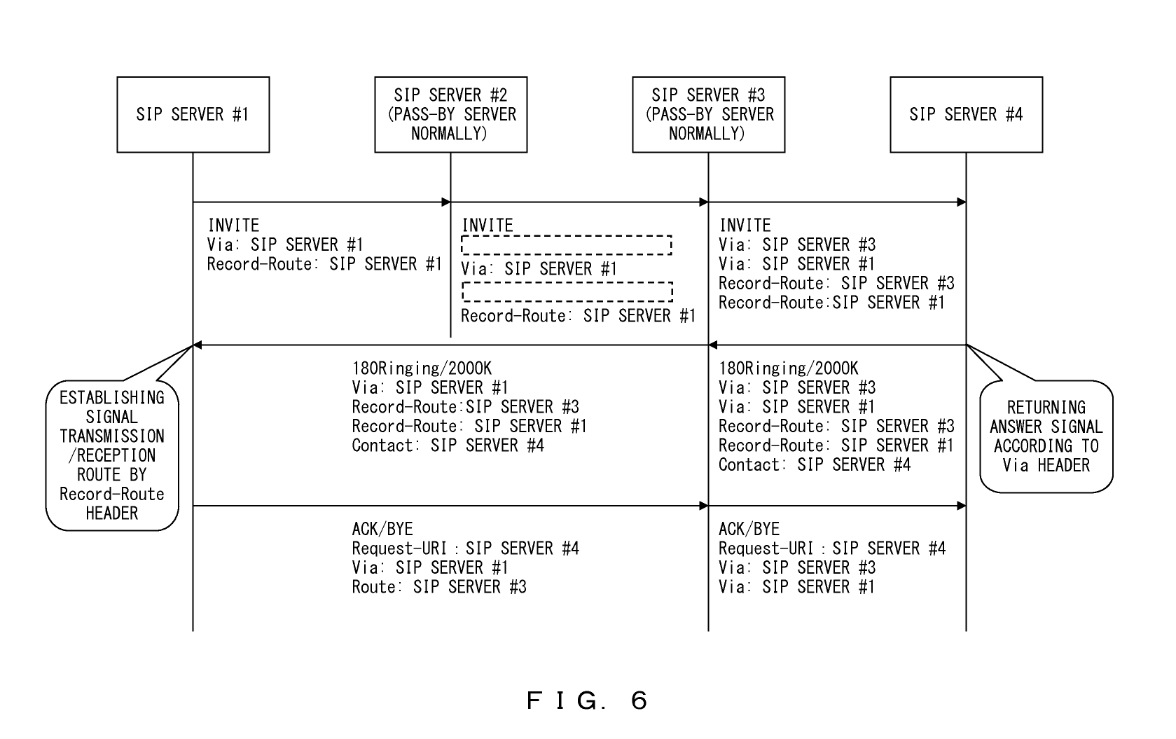

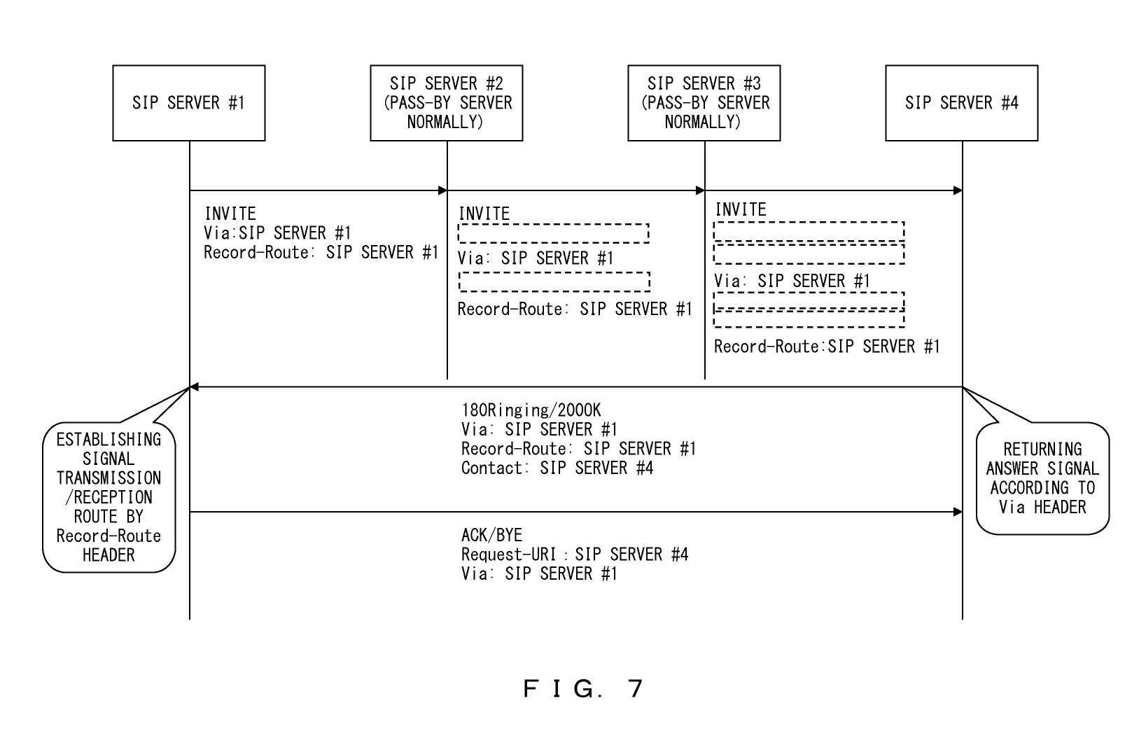

FIGS. 6 and 7 illustrate the SIP signal transmission/reception sequence when there are a plurality of SIP servers between a source and a destination according to an embodiment of the present invention.

When the response signal to the call raise request signal (INVITE) is received, and if there are SIP servers in a multiple stages and there is a track not including the server (SIP server #1) in the Record-Route header, then a set value of the Record-Route header is set as a destination in the Route header of a new request signal, and is transmitted.

The case in which there are SIP servers in multiple stages and there is a single pass-by server is illustrated in FIG. 6 as the SIP signal transmission/reception sequence when there is a single pass-by server.

In FIG. 6, the SIP server #2 is set as a pass-by server, and although it receives the INVITE signal from the SIP server #1, it does not write the track information about the SIP server #2 in the Via header or the Record-Route header. The SIP server #3 is not set as a pass-by server, and when it receives the INVITE signal from the SIP server #2, it writes the track information about the SIP server #3 to the Via header and the Record-Route header. Therefore, when the 180Ringing/2000K signal is transmitted from the SIP server #4 to the SIP server #1, it passes through the SIP server #3, but does not pass through the SIP server #2. The subsequent signals also pass through the SIP server #3, but do not pass through the SIP server #2. These operations can be realized by the settings of the Record-Route header.

The case in which there are SIP servers in multiple stages and there are a plurality of pass-by servers is illustrated in FIG. 7 as the SIP signal transmission/reception sequence when there are a plurality of pass-by servers.

In FIG. 7, the SIP servers #2 and #3 are set as pass-by servers, and when the INVITE signal is received from the SIP server #1, the servers do not write the information about the servers in the Via headers or the Record-Route headers when the servers #2 and #3 transfer the INVITE signal. Therefore, when the SIP server #4 transmits the 180Ringing/2000K signal, the signal is transmitted directly to the SIP server #1 because there is no information about the SIP servers #2 and #3 in the Via headers. In addition, since there is no information about the SIP servers #2 and #3 in the Record-Route headers, the signal does not pass through the SIP servers #2 and #3 after the establishment of the communication route, but is communicated directly between the SIP servers #1 and #4.

The determination of which SIP server is to be a pass-by server and which SIP server is to pass a signal through is performed by a system administrator by considering the items such as the geographic condition of a SIP server, the function of the SIP server as, for example, an exclusive server for allocating a signal, etc. In addition, the system administrator also sets each SIP server so that the track information about a source server is not written in the Via header or the Record-Route header.

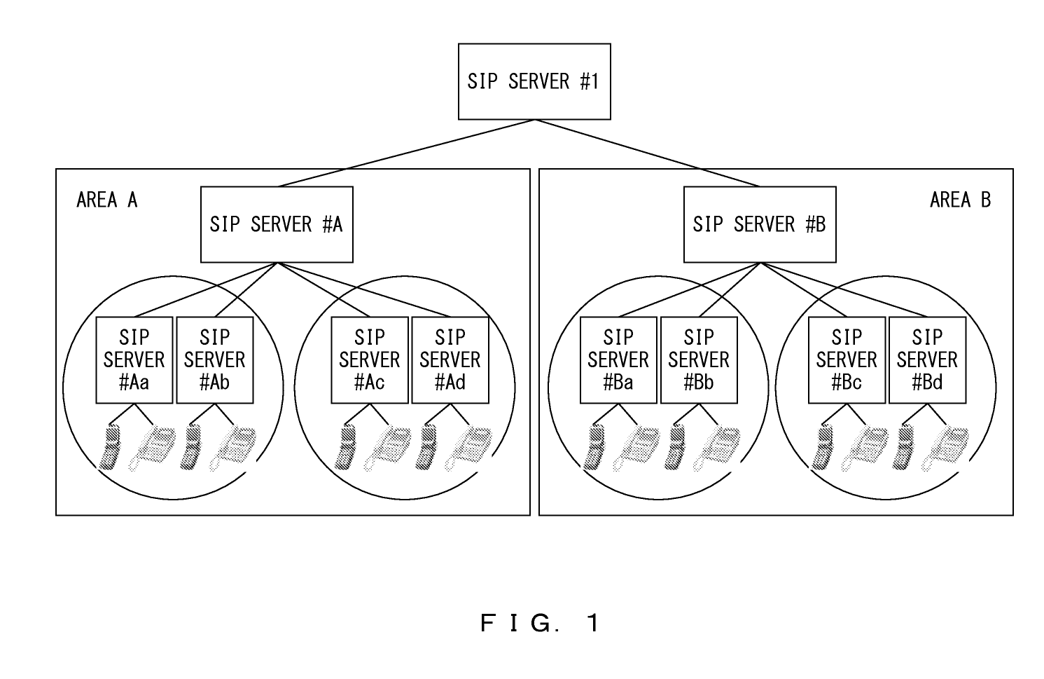

The operation above is described below with reference to FIG. 1. For example, if there is a service conditions of a fixed fee etc. in the communications in an area A, and when a communication is established from an SIP terminal under an SIP server #Aa to an SIP server under an SIP server #Ac, then it is necessary to pass through the SIP server #A that knows the destination SIP server. However, if the destination SIP server (#Ac) can be designated by the initial signal, it is not necessary to always pass through the SIP server #A in performing the communication in the area A. However, in the communication spanning the areas A and B, if it is necessary to consider the inter-area fee, a signal has to always pass through the SIP server #1.

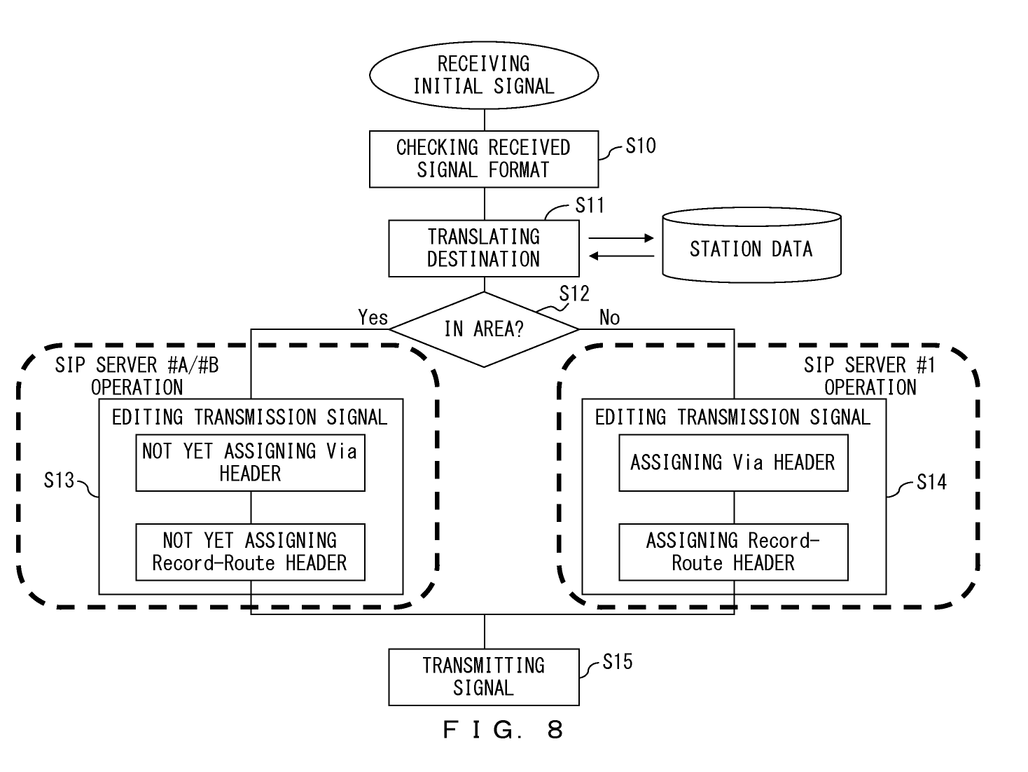

FIG. 8 is a flowchart of the operation of the SIP servers #1, #A, and #B illustrated in FIG. 1.

First, in step S10, the format of a received signal is checked. In step S11, a destination area is acquired from the destination address etc. The destination area can be acquired by searching the database stored in the station for managing the entire communication system. In step S12, it is determined that the area is located in an area A or an area B. The determination is made by determining whether or not the destination area is in the area A when the SIP server for performing the process in FIG. 8 is the SIP server #A, and whether or not the destination area is in the area B when the SIP server is the SIP server #B. When the SIP server is the SIP server #1, it is determined whether the destination are is in the area A or the area B.

If the determination in step S12 is YES, and when the SIP server is the SIP server #A or #B, then the transmission signal is generated without assigning the Via header and the Record-Route header in editing the transmission signal in step S13, and the signal is transmitted in step S15. If the determination in step S12 is NO, and when the SIP server is SIP server #1, then the transmission signal is generated by assigning the Via header and the Record-Route header in editing the transmission signal in step S14, and the signal is transmitted in step S15.

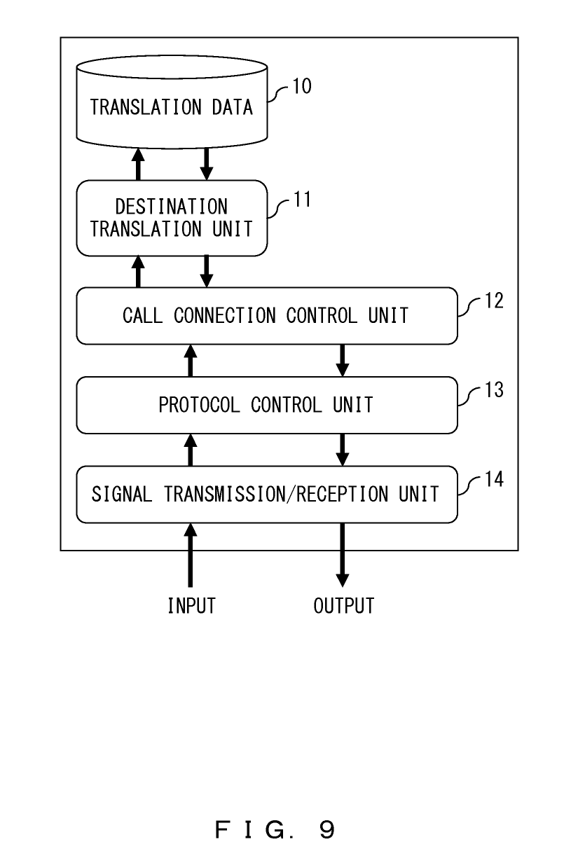

FIG. 9 is a block diagram of the functions of the SIP servers #1, #A, and #B illustrated in FIG. 1.

A signal transmission/reception unit 14 transmits and receives a signal. A protocol control unit 13 is a processing unit for performing a received signal according to a protocol, and processing the information to be interpreted and transmitted into a signal according to the protocol. A call connection control unit 12 is a processing unit for connecting a communication route of IP communications. A destination translation unit 11 refers to translation data 10 storing the correspondence between a destination address and a destination local area, and derives the local area of the destination.

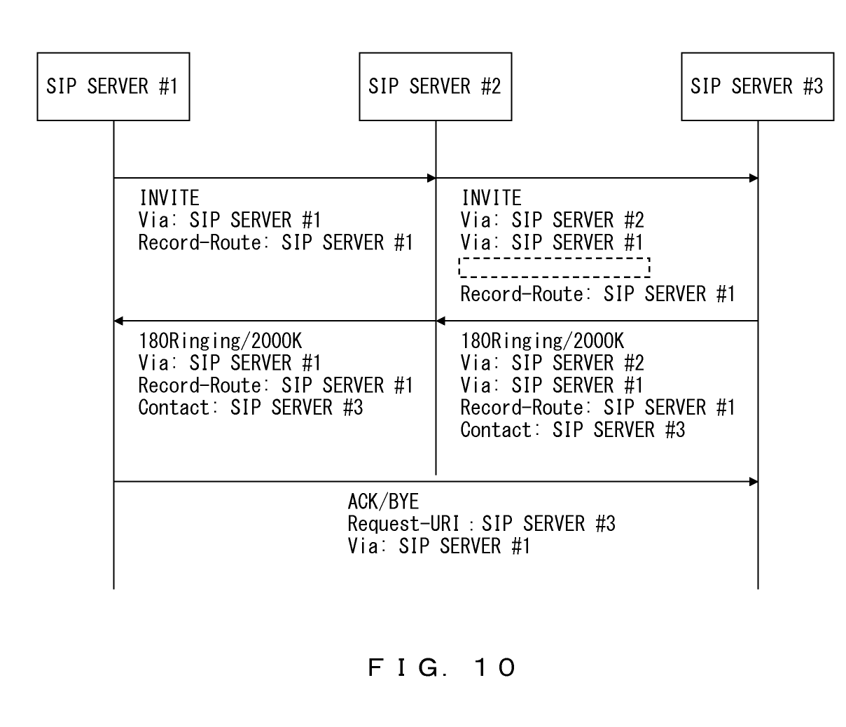

FIG. 10 is an explanatory view of an example of a variation of an embodiment of the present invention.

FIG. 10 illustrates the case in which a communication route is established between the SIP servers #1 and #3, and there is only the SIP server #2 between them. However, an example of the present embodiment can also be applied without fail although there are a plurality of SIP servers between the SIP servers #1 and #3.

In FIG. 4, when the INVITE signal is transferred, the SIP server #2 does not write the track information about the SIP server #2 to the Via header and the Record-Route header. Thus, the signals subsequent to the INVITE signal are transmitted and received without passing through the SIP server #2. In FIG. 10, the SIP server #2 does not write the track information about the SIP server #2 to the Record-Route header, but writes the track information about the SIP server #2 to the Via header. As a result, the answer signal (180Ringing/2000K signal) in response to the INVITE signal passes through the SIP server #2. However, the signal (ACK/BYE signal etc.) after the establishment of a communication route is transmitted and received without passing through the SIP server #2.

Thus, by changing the write to the Via header and the Record-Route header of a SIP server for relay, control can be performed to set the SIP server for relay as a pass-by server.

With the above-mentioned configuration, the load of the SIP server mainly operating for relay can be reduced, and the number of signals to be relayed can be decreased, thereby also reducing the number of SIP servers for relay.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A source communication apparatus which performs communications through a protocol for establishing a communication route, comprising:
a transfer unit to receive a signal, not to set normally set information about a source communication device in the received signal, but to transfer the received signal to another communication apparatus, thereby not to notify the other communication apparatus of the information about the source communication apparatus and to transfer the signal through a route bypassing the source communication apparatus.

2. The apparatus according to claim 1, wherein
a signal in which the information about the source communication apparatus is not set, is a first call raise request signal for establishing a communication route.

3. The apparatus according to claim 1, wherein
a protocol for establishing the communication route is a session initial protocol (SIP).

4. The apparatus according to claim 3, wherein
the information about the source communication apparatus is track information stored in a Via header or a Record-Route header in the SIP.

5. The apparatus according to claim 4, wherein
a signal in which the information about the source communication apparatus is not set, is an INVITE signal in the SIP.

6. A communication method for performing communications through a protocol for establishing a communication route, comprising:
receiving a signal, not setting normally set information about a source communication apparatus in the received signal, but transferring the received signal to another communication apparatus, thereby not notifying the other communication apparatus of the information about the source communication apparatus and transferring the signal through a route bypassing the source communication apparatus.
